(19) United States
(12) Patent Application Publication
(10) Pub. No.: US 2002/0114956 A1
(43) Pub. Date: Aug. 22, 2002

(54) Photochromic glass and process for its production

(75) Inventors: Hiroyuki Tomonaga, Yokohama-shi (JP); Takeshi Morimoto, Yokohama-shi (JP); Taki Matsumoto, Yokohama-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Asahi Glass Company, Limited, Chiyoda-ku (JP)

(21) Appl. No.: 09/988,727

(22) Filed: Nov. 20, 2001

Related U.S. Application Data
(63) Continuation of application No. PCT/JP00/03356, filed on May 25, 2000.

(30) Foreign Application Priority Data
May 25, 1999 (JP) 11-145485

(51) Int. Cl. B32B 9/00

(52) U.S. Cl. 428/432; 428/699; 428/702

(57) ABSTRACT

A photochromic glass excellent in coloration/color fading characteristics, which comprises a glass substrate and a photochromic film formed on the glass substrate, wherein the photochromic film comprises at least one metal selected from the group consisting of platinum, palladium, iridium, rhodium and gold, copper, silver halide crystallites and silicon oxide, and a process for its production.

### BACKGROUND OF THE INVENTION

1. Field of the Invention

The present invention relates to a photochromic glass and a process for its production.

2. Discussion of Background

A photochromic glass i.e. a glass which is colored by ultraviolet rays, is a glass which is expected to be useful not only as a window material but also for hologram elements, etc. Materials which show photochromic properties include inorganic materials such as silver halides or metal oxides (such as titanium oxide), and organic materials such as diaryl ethenes or spiropyran. From the viewpoint of light resistance as the most important factor for durability of photochromic glasses, inorganic materials are generally superior.

Among inorganic materials, silver halide type photochromic glasses are practically used for sunglasses. A silver halide type photochromic glass is one prepared by adding silver and halogen to a molten base material for glass, followed by vitrification and then by reheating to let a silver halide precipitate in the glass.

However, the base material for glass is not soda lime glass which is commonly used for window glass, but is aluminoborosilicate or phosphosilicate glass. Accordingly, if such glass is to be applied to a window material, etc., a dedicated furnace or production line will be required. Under these circumstances, a production method is desired which is capable of simply forming a thin coating film having photochromic properties on a glass substrate.

Heretofore, some methods have been proposed to form a silver halide type photochromic coating film on a glass substrate.

For example, 1) a method wherein a solution containing an alkoxysilane and a soluble silver salt, is coated on a glass substrate, followed by halogenation treatment in a hydrogen chloride gas (SPIE Proc., 1590, 152-159 (1991)) or 2) a method wherein, using an alkoxysilane having bonded thereto a hydrocarbon group with its terminals substituted by halogen, a film is subjected to high temperature heat treatment to generate free halogen by thermal decomposition (J. Sol-Gel Sci, Tech., 1,217-231 (1994)), has been proposed.

However, by the method 1), corrosiveness of the hydrogen chloride gas is strong, whereby handling is inconvenient, and the formed film is likely to be eroded. On the other hand, by the method 2), thermal decomposition at a high temperature is required, whereby silver halide crystals tend to grow to be coarse, so that color fading tends to hardly proceed. Accordingly, heating to a few hundred degrees in centigrade will be required for color fading, and depending upon the thermal decomposition temperature, sublimation and dissipation of the silver halide are likely to take place, whereby the photochromic properties may be impaired.

### SUMMARY OF THE INVENTION

In view of the foregoing problems of the prior art, it is an object of the present invention to provide a photochromic glass which comprises a substrate and a coating film formed thereon and which has coloration and color fading characteristics of a level equal to a photochromic glass obtainable by a melting method, and a process for its production.

The present invention provides a photochromic glass comprising a glass substrate and a photochromic film formed on the glass substrate, wherein the photochromic film comprises at least one metal selected from the group consisting of platinum, palladium, iridium, rhodium and gold, copper, silver halide crystallites and silicon oxide.

### BRIEF DESCRIPTION OF THE DRAWING

FIG. 1 is a graph showing the change with time of the transmittance of the photochromic glass obtained in Example 2.

### DETAILED DESCRIPTION OF THE PREFERRED EMBODIMENTS

The silver halide crystallites are a material essential to develop the photochromic properties. The silver halide may, for example, be silver chloride, silver bromide or silver iodide. These silver halides may be used alone or in combination as a mixture or a solid solution of two or more of them. The crystallite size is preferably from 5 to 100 nm, particularly preferably from 5 to 30 nm.

The silicon oxide is present as a vitreous matrix component to have silver halide crystallites dispersed therein. The silicon oxide is not required to have a strict SiO₂ composition and may be present as an amorphous component having a network Si-o-Si bonds.

Further, as a matrix component, it may contain B, Al, P, Zr, Ti or the like as a network-forming atom, and it may contain an alkali metal ion or an alkaline earth metal ion as a modifying ion.

The copper serves as a sensitizer to accelerate coloration or color fading of the photochromic film. The molar ratio of silver (Ag)/copper (Cu) in the photochromic film is preferably from 100/0.01 to 100/20. If the Cu content is too small, the sensitizing effect is likely to be low, and if the Cu content is excessive, the sensitizing effect is also likely to be low.

Particularly preferably, the molar ratio of Ag/Cu is from 100/5 to 100/15, still further preferably from 100/8 to 100/12.

At least one metal (hereinafter referred to simply as noble metal M) selected from the group consisting of platinum (Pt), palladium (Pd), iridium (Ir), rhodium (Rh) and gold (Au) remarkably improves the sensitizing effect of Cu. The molar ratio of Ag/(total amount of noble metal M) in the photochromic film is preferably from 100/0.1 to 100/20. If the content of noble metal M is too small, the effects of the addition tend to be inadequate, and if it is excessive, no further improvement of the effect will be observed. Particularly preferably, the molar ratio of Ag/(total amount of noble metal M) is from 100/2 to 100/15, still further preferably from 100/8 to 100/12.

The photochromic glass of the present invention is initially colorless transparent, but will be colored by irradiation with ultraviolet rays, and then, color fading gradually proceeds when it is left in a dark place at room temperature. The coloration property and the color fading property required, may vary depending upon the particular use. In the case of an application as a window material, the visible light transmittance when colored by irradiation of ultraviolet rays for 10 minutes with an illuminance of 1 mW/cm², is preferably at most 60%, particularly preferably at most 50%. Further, the visible light transmittance when it is left for one hour in a dark place for color fading, is preferably at least 80%. Further, with respect to the film strength of the photochromic glass of the present invention, the required durability may vary depending upon the particular use, but when it is used as a window material, it is usually desired that no peeling is observed in the abrasion resistance test disclosed in JIS R3212.

The present invention also provides a process for producing a photochromic glass, which comprises coating on a glass substrate a coating solution containing superfine particles containing Ag, a first silicon compound and a compound which liberates halogen by thermal decomposition, followed by heating to form a lower layer film, and then, coating on the lower layer film a coating solution containing noble metal M or a compound of noble metal M, a second silicon compound and a Cu compound, followed by heating to form an upper layer film.

Hereinafter, the step for forming the lower layer film will be referred to as Step 1, and the step for forming the upper layer film will be referred to as Step 2.

Step 1 is a step of forming a photochromic coating film having silver halide crystallites precipitated in the silicon oxide coating film.

The superfine particles containing Ag are preferably introduced in the form of a colloidal dispersion in order to have the dispersed state in the coating solution maintained. For example, a colloidal dispersion of Ag is preferably obtained by wet reduction of a soluble salt such as silver nitrate.

As the dispersing medium, water is most preferably employed, and an organic solvent such as an alcohol may be added thereto. The solid content concentration of the colloidal dispersion is preferably from 1 to 20 mass %. If the concentration is less than 1 mass %, development of the photochromic properties tends to deteriorate, and if it exceeds 20 mass %, the stability of the dispersion itself is likely to be poor.

As the superfine particles containing Ag, it is preferred to employ superfine particles made of an alloy of Ag and Cu with a view to improving the coloration degree. In the superfine particles made of an alloy of Ag and Cu, the mass ratio of Ag/Cu is preferably from 99.99/0.01 to 95/5, since if it contains Cu excessively, it may inversely act as a coloration inhibitor.

The average particle size of the superfine particles containing Ag is preferably at most 50 nm. If it exceeds 50 nm, the transparency of the obtainable coating film tends to be low. It is particularly preferably at most 20 nm. On the other hand, if it is too small, the photochromic properties tend to be lost, and accordingly, it is preferably at least 5 nm. The average particle size can be examined by the microscopic observation.

The first silicon compound is used as a component which forms a vitreous coating film. As such a first silicon compound, it is preferred to use an alkoxysilane compound of the formula RₐSiX₄₋ₐ wherein R is an organic group which may be substituted (preferably an organic group which may be substituted by an element other than a halogen element), X is an alkoxy group, and a is an integer of from 0 to 2, provided that the plurality of X may be the same or different groups, and when a is 2, the two R may be the same or different groups.

Specifically, the alkoxysilane compound as the first silicon compound may, for example, be tetramethoxysilane, tetraethoxysilane, a condensate of tetramethoxysilane (such as “methyl silicate 51”, trade name), a condensate of tetraethoxysilane (such as “ethyl silicate 40”, trade name), methyltrimethoxysilane, phenyltrimethoxysilane, 3-glycidoxypropyltrimethoxysilane, 3-glycidoxypropylmethyldimethoxysilane, 3-methacryloxypropyltrimethoxysilane, dimethyldimethoxysilane or diphenyldimethoxysilane.

The alkoxysilane compound is preferably present in a solution in the form hydrolyzed by an addition of water. By the hydrolysis of the alkoxy group, it functions as a binder, and by controlling the conditions for the hydrolysis, a proper network structure can be formed in the solution.

The compound which liberates halogen by thermal decomposition (hereinafter referred to simply as a halogen-liberating compound), liberates halogen during the heating in Step 1, which will directly react with superfine particles containing Ag to form silver halide crystallites. Accordingly, it is required that the compound does not liberate halogen in the coating solution, and it liberates halogen by the thermal decomposition. Further, in this specification, “halogen” is meant for at least one member selected from chlorine, bromine and iodine. Especially from the viewpoint of the coloration property under irradiation and the transparency at the time of the color fading, chlorine or bromine is preferred. Further, when the halogen-liberating compound is a silicon compound, it is a compound different from the first silicon compound.

In the present invention, as the halogen-liberating compound, it is preferred to employ a trihalogeno acetic acid compound (such as trichloroacetic acid or tribromoacetic acid) or an alkoxysilane compound having a halogen-containing organic group directly bonded to Si (such as 3-chloropropyltrimethoxysilane or 3-bromopropyltriethoxysilane). Further, the trihalogeno acetic acid compound is meant for a trihalogeno acetic acid and its derivatives and includes a trihalogeno acetic acid salt and a trihalogeno acetic acid ester.

In the present invention, the molar ratio of Ag/silicon (Si) in the coating solution for forming the lower layer film, is preferably from 1/5 to 1/20. If the Ag content is excessive to Si, the coating film-forming component tends to be relatively small, and the film-forming property tends to be poor. On the other hand, if the Ag content is too small relative to Si, an effective coloring property cannot be imparted.

Further, the molar ratio (atomic ratio) of Ag/halogen in the coating solution for forming the lower layer film, is preferably from 2/1 to 1/10. If the halogen content is too small relative to Ag, the amount of Ag not involved for the formation of the silver halide tends to be large, and if halogen is excessive relative to Ag, coloration tends to be difficult.

To the coating solution to be used in Step 1, it is possible to add a hydrophilic organic solvent (such as an alcohol) or a surfactant to improve the coating property, or a dispersing agent or the like to improve the dispersibility of the colloid.

Further, it is possible to add a compound of e.g. zirconium, titanium, aluminum, boron or phosphorus, or a compound of an alkali metal or an alkaline earth metal, which can be a component for forming the vitreous coating film.

As the coating method, a known method may be employed. For example, a dip coating method, a spin coating method, a spray coating method, a flow coating method, a die coating method, a roll coating method, a transfer printing method or a screen printing method may be mentioned.

The heating temperature in Step 1 is preferably at least 100° C. When an alkoxysilane compound having a halogen-containing organic group directly bonded to Si, is used as the halogen-liberating compound, the heating temperature is preferably from 250 to 500° C. (particularly from 300 to 500° C.) and when a trihalogeno acetic acid compound is used, it is preferably from 100 to 500° C. (particularly from 200 to 500° C.). If the temperature exceeds 500° C., the liberated halogen is likely to be dissipated in the coating film.

The thickness of the lower layer film obtained in Step 1, is preferably from 100 to 10,000 nm. If it is less than 100 nm, an effective coloration property can hardly be provided, and if it exceeds 10,000 nm, the coating film tends to have cracks or tends to peel. Particularly preferably, the thickness of the lower layer film is from 100 to 3,000 nm.

The lower layer film will be colored by light and exhibits a photochromic property by itself, but heating is required for color fading. By the addition of Step 2, the color fading can be accelerated, and it is possible to obtain a photochromic glass whereby coloration and color fading cycles will be possible at room temperature.

The second silicon compound to be used in Step 2, is used also as a component which forms the vitreous coating film. As such a second silicon compound, it is preferred to employ the same alkoxysilane compound as the first silicon compound. Further, as the second silicon compound, colloidal silica or the like (such as colloidal silica dispersed in water or in an organic solvent) is preferred.

A Cu compound is used to accelerate the color fading of the photochromic coating film in a dark place. As such a Cu compound, a soluble inorganic salt such as copper nitrate, copper chloride or copper sulfate, or an organic metal compound such as an acetate, an acetyl acetonate or an alkoxide, may, for example, be used. Otherwise, superfine particles of copper oxide having an average particle size of at most 50 nm may be dispersed in the coating solution. As the Cu compound, it is preferred to employ at least one Cu compound selected from the group consisting of copper nitrate, copper chloride, copper bromide, copper acetate and copper sulfate, from the viewpoint of the solubility in a silicon compound solution.

By the formation of the upper layer film, the photochromic properties (particularly the color fading property in a dark place) will be remarkably improved. The lower layer film is obtained by the decomposition of an organic substance present in the coating film and is microscopically a coating film having a relatively large porosity. Accordingly, it is conceivable that the coating solution for forming the upper layer film will penetrate into the lower layer film, and it is considered that Cu and noble metal M penetrated and diffused in the lower layer film serve to remarkably improve the color fading property of the lower layer film. Further, the second silicon compound forms a protective film covering the surface of the lower layer film and thus suppresses dissipation, etc. of the silver halide in the lower layer film.

In the present invention, the molar ratio of Cu/Si in the coating solution for forming the upper layer film is preferably from 0.01 to 0.1. If it is less than 0.01, no adequate effect of the addition of the Cu compound tends to be obtainable, and if it exceeds 0.1, the transparency of the resulting coating film is likely to be impaired, and the photochromic properties may inversely deteriorate.

Further, also to the coating solution for forming the upper layer film, it is possible to add a compound of e.g. zirconium, titanium, aluminum, boron or phosphorus, or a compound of an alkali metal or an alkaline earth metal, which can be a component for forming the vitreous coating film.

Noble metal M or a compound of noble metal M in the coating solution for forming the upper layer film, may be one having superfine particles of noble metal M dispersed, a soluble organic salt or a soluble inorganic salt. The molar ratio of (total amount of noble metal M)/Si in the coating solution for forming the upper layer film is preferably from 0.01 to 0.1. If the content of noble metal M is too small, no adequate effect of the addition will be obtainable, and if it is excessive, the coloration property and the color fading property may be impaired.

As the coating method, the same various methods as in the above-described Step 1, may be used.

The heating temperature in Step 2 is preferably at least 200° C. The upper limit is preferably 500° C. If the temperature exceeds 500° C., the silver halide in the lower layer film is likely to dissipate. Particularly preferably, the heating temperature is from 200 to 500° C., still further preferably from 300 to 500° C.

The thickness of the upper layer film cannot be defined in a strict sense, because of the penetration into the lower layer film as mentioned above. However, if it is defined by (the total thickness of the two layer films)-(the thickness of the lower layer film), the thickness of the upper layer is preferably from 30 to 2,000 nm. If it is less than 30 nm, the amount of Cu or noble metal M required for acceleration of the color-fading tends to be deficient, and if it exceeds 2,000 nm, the coating film is likely to have cracks. Particularly preferably, the thickness of the upper layer is from 50 to 200 nm.

The glass substrate to be used in the present invention is not particularly limited, and it may, for example, be a soda lime glass substrate, a borosilicate glass substrate, an alkali-free glass substrate or a quartz glass substrate. When a glass substrate containing a large amount of an alkali component such as a soda lime glass substrate, is used as the glass substrate, along with migration of an alkali from the glass substrate, Ag ions in the coating film tend to be ion-exchanged and diffuse into the glass substrate. Accordingly, in order to prevent such migration, it is preferred to employ a glass substrate having a film composed mainly of silicon oxide (such as a SiO₂ film) formed on the surface of the glass substrate, on which the coating film is to be formed.

### EXAMPLES

Now, the present invention will be described in further detail with reference to Examples. However, it should be understood that the present invention is by no means restricted to the following Examples.

Preparation of Colloidal Ag Dispersion A

500 g of a 30% aqueous solution of ferrous sulfate and 700 g of a 30% aqueous solution of trisodium citrate were mixed, and while thoroughly stirring the mixture, 500 g of a 10% aqueous solution of silver nitrate was dropwise added. The obtained precipitate was thoroughly washed with pure water. Then, pure water was added so that the Ag concentration would be 5 mass % and dispersed again to obtain colloidal Ag dispersion A (hereinafter referred to simply as Ag colloid solution A). As a result of an electron microscopic observation, the average particle size of the obtained Ag superfine particles was about 10 nm.

Preparation of Colloidal Ag/Cu Alloy Dispersion B

To 160 g of a solution obtained by diluting the Ag colloid solution A with pure water so that the solid content would be 2%, 40 g of a 30% aqueous solution of trisodium citrate and 20 g of a 30% aqueous solution of ferrous sulfate were added. Then, 10 g of a 2% aqueous solution of copper nitrate was dropwise added. The obtained precipitate was thoroughly washed with pure water. Then, water was added so that the concentration of the total of Ag and Cu would be 5 mass % and dispersed again to obtain colloidal Ag/Cu alloy dispersion B (hereinafter referred to simply as Ag/Cu colloid solution B). With respect to the solid content in the obtained dispersion, the composition was analyzed, whereby the mass ratio of Ag/Cu was 99.5/0.5. As a result of an electron microscopic observation, the average particle size of the obtained Ag/Cu alloy superfine particles was about 10 nm.

### Example 1

6.2 g of methyltrimethoxysilane, 36 g of 3-chloropropyltrimethoxysilane and 20 g of ethanol were mixed, and 12 g of an aqueous nitric acid solution of pH 4 was added thereto, followed by a reaction at room temperature for 24 hours to obtain a liquid, to which 49 g of Ag colloid solution A was added, and 0.2 g of dimethyl silicone was added, to obtain coating solution C. The molar ratio of Ag/Si in the coating solution C was 0.1, and the molar ratio of Ag/halogen (chlorine only in this case) was 0.125. A soda lime glass substrate of 100 mm×100 mm having a SiO₂ film formed in a thickness of 100 nm, was prepared, and on the surface of the substrate on which the SiO₂ film was formed, the coating solution C was coated by a spin coating method, then dried at 60° C. for 15 minutes and then heated at 330° C. for 15 minutes to form a lower layer film having silver chloride crystallites precipitated in the silicon oxide film. The glass substrate on which the lower layer film was formed, was transparent, and the thickness of the lower layer film was 1,000 nm, and the transmittance of the glass substrate on which the lower layer film was formed, was 90%.

10.4 g of tetraethoxysilane, 0.6 g of copper nitrate, 78 g of ethanol, 1.3 g of chloroplatinic acid and 7 g of a 1% aqueous solution of nitric acid, were mixed and stirred at room temperature for two hours to obtain coating solution D for the upper layer film. In the coating solution D, the molar ratio of Cu/Si was 0.05, and the molar ratio of Pt/Si was 0.05. This coating solution D was coated on the above-mentioned lower layer film by a spin coating method, then dried at 100° C. for 5 minutes and then heated at 400° C. for 30 minutes to form an upper layer film. The thickness of the upper layer film was 100 nm, and the transmittance of the glass provided with the two layers, was 84%. As a result of the fluorescent X-ray analysis, the molar ratios of Ag/Cu and Ag/(total amount of noble metal M=platinum only in this example) in the photochromic film were 100/9.6 and 100/10.3 respectively.

The obtained photochromic glass was irradiated with ultraviolet rays for 10 minutes with an illuminance of 1 mW/cm² via a low pass filter of 275 nm by means of a 1.5 kW xenon lamp, whereby the photochromic glass was colored brown, and the transmittance became 59%. Further, when this photochromic glass was left in a dark place, the transmittance recovered to a level of 76% upon expiration of 15 minutes, 81% upon expiration of 60 minutes and 83% upon expiration of 10 hours. The results are shown in Table 1.

Further, the durability was examined by carrying out a test of repeating a cycle of irradiating the sample with ultraviolet rays and then leaving it in a dark place for 10 hours. However, no change in the coloration and color fading characteristics was observed even when 30 cycles were repeated. Further, evaluation was made by the difference (ΔT) between the initial transmittance and the transmittance after the sample was subjected to a test (hereinafter referred to as a durability test) of repeating 30 cycles and then left to stand in a dark place for 10 hours. ΔT being at most 3% is represented by symbol ∘, ΔT being more than 3% and less than 10% by symbol Δ, and ΔT being 10% or more by symbol ×. The results of the durability tests are also shown in Table 1.

### Example 2

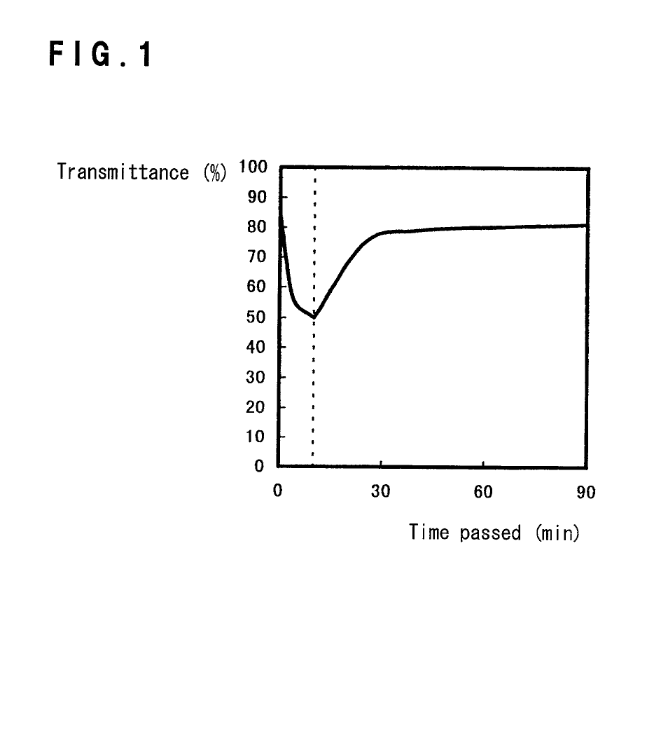

A photochromic glass was obtained in the same manner as in Example 1 except that Ag colloid solution A was changed to Ag/Cu colloid solution B. The thicknesses of the lower layer film and the upper layer film were 1,000 nm and 100 nm, respectively. The results are shown in Table 1. The photochromic glass obtained in Example 2 was irradiated with ultraviolet rays for 10 minutes in the same manner as in Example 1 and then left in a dark place. The change with time of the transmittance is shown in FIG. 1.

### Example 3

The operation was carried out in the same manner as in Example 2 except that 1.3 g of chloroplatinic acid used in Example 2 was changed to 1.05 g of chloroauric acid. The molar ratio of Au/Si in the coating solution for the upper layer film was 0.05. The thicknesses of the lower layer film and the upper layer film were 1,000 nm and 100 nm, respectively. The results are shown in Table 1.

### Example 4

The operation was carried out in the same manner as in Example 2 except that 1.3 g of chloroplatinic acid used in Example 2 was changed to 0.90 g of iridium chloride. The molar ratio of Ir/Si in the coating solution for the upper layer film was 0.05. The thicknesses of the lower layer film and the upper layer film were 1,000 nm and 100 nm, respectively. The results are shown in Table 1.

### Example 5

The operation was carried out in the same manner as in Example 2 except that 1.3 g of chloroplatinic acid used in Example 2 was changed to 0.90 g of rhodium chloride. The molar ratio of Rh/Si in the coating solution for the upper layer film was 0.05. The thicknesses of the lower layer film and the upper layer film were 1,000 nm and 100 nm, respectively. The results are shown in Table 1.

### Example 6

The operation was carried out in the same manner as in Example 2 except that 1.3 g of chloroplatinic acid used in Example 2 was changed to 6.5 g of an aqueous palladium nitrate solution (Pd: 4.5 mass %). The molar ratio of Pd/Si in the coating solution for the upper layer film was 0.05. The thicknesses of the lower layer film and the upper layer film were 1,000 nm and 100 nm, respectively. The results are shown in Table 1.

### Example 7

The operation was carried out in the same manner as in Example 2 except that 1.3 g of chloroplatinic acid used in Example 2 was changed to 0.40 g of chloroplatinic acid. The molar ratio of Pt/Si in the coating solution for the upper layer film was 0.015. The thicknesses of the lower layer film and the upper layer film were 1,000 nm and 100 nm, respectively. The results are shown in Table 1.

### Example 8

The operation was carried out in the same manner as in Example 2 except that 1.3 g of chloroplatinic acid used in Example 2 was changed to 0.65 g of chloroplatinic acid. The molar ratio of Pt/Si in the coating solution for the upper layer film was 0.025. The thicknesses of the lower layer film and the upper layer film were 1,000 nm and 100 nm, respectively. The results are shown in Table 1.

### Example 9 (Comparative Example)

The operation was carried out in the same manner as in Example 2 except that no chloroplatinic acid was added to the coating solution for the upper layer film. The thicknesses of the lower layer film and the upper layer film were 1,000 nm and 100 nm, respectively. The results are shown in Table 1.

### Example 10 (Comparative Example)

The operation was carried out in the same manner as in Example 2 except that no copper nitrate was added to the coating solution for forming the upper layer film. The thicknesses of the lower layer film and the upper layer film were 1,000 nm and 100 nm, respectively. The results are shown in Table 1.

In each of Examples 1 to 8, the crystallite sizes of the silver halide crystallites in the film were from about 15 to 30 nm.

Further, with respect to photochromic glasses obtained in Examples 1 to 8, Taber abrasion tests disclosed in JIS R3212 were carried out to evaluate the film strength, whereby in each case, no peeling was observed, and it was confirmed that each glass had excellent film strength.

TABLE 1

| | Type | | | | Transmittance | Transmittance | Transmittance | |
|---|---|---|---|---|---|---|---|---|
| | of | | | | after | after being | after being | |
| | noble | | Noble | | irradiation | left in | left in | |
| | metal | | metal | Initial | with ultra- | dark place | dark place | |
| | M | Cu/Ag | M/Ag | transmit- | violet | for 15 | for 60 | Durability |
| Ex. | (mol %) | (mol %) | (mol %) | tance (%) | rays (%) | minutes (%) | minutes (%) | test |
| 1 | Pt | 9.6 | 10.1 | 84 | 59 | 76 | 81 | ∘ |
| 2 | Pt | 10.3 | 9.5 | 84 | 50 | 75 | 81 | ∘ |
| 3 | Au | 10.2 | 10.9 | 81 | 53 | 68 | 78 | ∘ |
| 4 | Ir | 10.3 | 9.3 | 82 | 54 | 65 | 76 | ∘ |
| 5 | Rh | 10.3 | 8.6 | 83 | 57 | 63 | 77 | ∘ |
| 6 | Pd | 10.2 | 9.9 | 81 | 56 | 68 | 76 | ∘ |
| 7 | Pt | 10.4 | 2.6 | 84 | 55 | 75 | 81 | ∘ |
| 8 | Pt | 10.2 | 5.5 | 84 | 53 | 75 | 81 | ∘ |
| 9 | Nil | 10.2 | — | 89 | 59 | 68 | 74 | Δ |
| 10 | Pt | 0.8 | 10.0 | 88 | 57 | 59 | 61 | × |

According to the present invention, by a simple process of coating and heating, a photochromic coating film can be formed on a glass substrate to obtain a photochromic glass having coloration and color fading characteristics of a level equal to a photochromic glass obtainable by a melting method.

The entire disclosure of Japanese Patent Application No. 11-145485 filed on May 25, 1999 including specification, claims, drawings and summary are incorporated herein by reference in its entirety.

What is claimed is:

1. A photochromic glass comprising a glass substrate and a photochromic film formed on the glass substrate, wherein the photochromic film comprises at least one metal selected from the group consisting of platinum, palladium, iridium, rhodium and gold, copper, silver halide crystallites and silicon oxide.

2. The photochromic glass according to claim 1, wherein the molar ratio of silver/copper in the photochromic film is from 100/0.01 to 100/20.

3. The photochromic glass according to claim 1, wherein the molar ratio of silver/(total amount of platinum, palladium, iridium, rhodium and gold) is from 100/0.1 to 100/20.

4. A process for producing a photochromic glass, which comprises coating on a glass substrate a coating solution containing superfine particles containing silver, a first silicon compound and a compound which liberates halogen by thermal decomposition, followed by heating to form a lower layer film, and then, coating on the lower layer film a coating solution containing at least one metal selected from the group consisting of platinum, palladium, iridium, rhodium and gold, or a compound of such metal, a second silicon compound and a copper compound, followed by heating to form an upper layer film.

5. The process for producing a photochromic glass according to claim 4, wherein the superfine particles containing silver, are superfine particles made of an alloy of silver and copper, wherein the mass ratio of silver/copper is from 99.99/0.01 to 95/5.

6. The process for producing a photochromic glass according to claim 4, wherein the superfine particles containing silver, have an average particle size of at most 50 nm.

7. The process for producing a photochromic glass according to claim 4, wherein an alkoxysilane compound of the formula RₐSiX₄₋ₐ wherein R is an organic group which may be substituted, X is an alkoxy group, and a is an integer of from 0 to 2, provided that the plurality of X may be the same or different groups, and when a is 2, the two R may be the same or different groups, is used as the first silicon compound and/or the second silicon compound.

8. The process for producing a photochromic glass according to claim 4, wherein a trihalogenoacetic acid compound or an alkoxysilane compound having a halogen-containing organic group directly bonded to Si, is used as the compound which liberates halogen by thermal decomposition.

9. The process for producing a photochromic glass according to claim 4, wherein as the copper compound, at least one copper compound selected from the group consisting of copper nitrate, copper chloride, copper bromide, copper acetate and copper sulfate, is used.
